(19) United States
(12) Patent Application Publication
(10) Pub. No.: US 2003/0169817 A1
(43) Pub. Date: Sep. 11, 2003

(54) Method to encode moving picture data and apparatus therefor

(75) Inventors: Byung-cheol Song, Gyeonggi-do (KR); Kang-wook Chun, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/288,573

(22) Filed: Nov. 6, 2002

(30) Foreign Application Priority Data
Mar. 5, 2002 (KR) 2002-11644

(51) Int. Cl. H04N 7/12

(52) U.S. Cl. 375/240.13; 375/240.08; 348/700

(57) ABSTRACT

A method and apparatus to encode a moving picture data for a personal video recorder (PVR) and a retrieval of a content-based picture. In the method to encode the moving picture data the moving picture data having a plurality of frames is segmented into a group of pictures (GOP) including an I frame (intrapicture), a B frame (bi-directionally predicted picture), and a P frame (predicted picture) and is encoded. A boundary between shots is extracted from the inputted video data. The method and apparatus determine whether a frame to be encoded is a first frame (boundary frame) of a next shot. The GOP is terminated in a frame (previous frame) right before a key frame, and a new GOP starts from the boundary frame when the frame to be encoded is the boundary frame.

### CROSS-REFERENCE TO RELATED APPLICATIONS

This application claims the benefit of Korean Application No. 2002-11644 filed Mar. 5, 2002, in the Korean Intellectual Property Office, the disclosure of which is incorporated herein by reference.

### BACKGROUND OF THE INVENTION

1. Field of the Invention

The present invention relates to a method to encode a moving picture signal, and more particularly, to method and apparatus to encode moving picture data suitable for a personal video recorder (PVR) and a retrieval of a content-based picture.

2. Description of the Related Art

As a digital age emerges, an interest in personal video recorders (PVRs) increases to record broadcasting programs for more than 24 hours without an additional video tape. PVRs, which are also called digital video recorders (DVRs) have a hard disk drive (HDD) in which a digital video stream that is being broadcasted is stored and reproduced in real-time.

Due to the HDD installed in the PVRs, unlike a conventional analog VCR tape, audio and video information is digitally stored in the HDD, thereby guaranteeing picture quality without information losses and enabling to perform a similar function to that of the VCRs, even though recording and reproduction are performed indefinitely.

A core function of the PVRs is a streaming processing function in which a broadcasting stream is freely recorded and reproduced using a high speed HDD having a large capacity. Moving picture data such as MPEG2, has a continuity over time and has very high characteristics to read and write at an arbitrary point like in the HDD, compared to other storage media. Thus, even though the moving picture data is limited by physical disc apparatuses, such as track movement of disc heads, storing and reproducing consecutive media in real-time is sufficiently guaranteed.

Another main function of PVRs is a personal TV agent function. The personal TV agent function is an improved video navigation function such as video indexing, using metadata received additionally from a broadcasting program or an Internet connection, or self-extracted main frame data.

The field in which XML-based metadata-related techniques are mainly used, is expected to be settled as an industrial standard that includes manufacturing contents and a consumption of a final consumer. Due to the XML-based metadata-related techniques, moving picture-based services such as program guides, video indexing, channel and program searching, and recording of each highlight and episode, can be performed, and a personal TV age where a TV can be configured according to a profile in use is emerging.

Meanwhile, as an amount of multimedia information increases at a very high speed, an effective management of the multimedia information is very important, and in particular, a user's demand to provide multimedia information increases.

Content-based retrieval is one of retrieving methods to effectively perform retrieval and reproduction of multimedia information and enables extraction of features (color, texture, and shape information) of a picture and effectively use of an increasing amount of picture information through the retrieval of a data index structure for efficiency of the retrieval.

Features used in content-based retrieval are shape, texture, and color. These features can be represented by a numerical value, and thus can be easily stored and retrieved. At present, with regard to content-based retrieval, a standarization of MPEG-7 (ISO/IEC 15938) is progressing.

FIG. 1 illustrates features of content-based retrieval. Video data and feature vectors extracted from the video data are stored in a database 102, and the video data is retrieved and reproduced using the feature vectors.

In order to extract the feature vectors from the video data, the video data is segmented in units of a scene, and the feature vectors such as a boundary frame (first frame of a next scene) or a key frame (as a key frame of a corresponding scene), are extracted from the video data.

The feature vectors are indexed such that the video data is retrieved, and the feature vectors are linked with a pointer which indicates a boundary frame and a key frame.

Korean Patent Publication No. 1999-3248 (applicant: Hyundai Electronics Co., Ltd., filed on Feb. 1, 1999, and published, on Sep. 5, 2000) discloses a retrieving apparatus and method using a moving picture index descriptor having a tree structure, in which a moving picture index having the tree structure is created on a basis of contents of the moving picture data. The moving picture index is made as a descriptor and is applied to a retrieval system such that the retrieval of the moving picture data is easily performed.

Content-based retrieval is performed on the indexed feature vector. In the case of reproduction in units of a shot, the boundary frame indicated by the pointer linked with the searched feature vectors is reproduced. In the case of a reproduction of the key frame, the key frame indicated by the pointer linked with the searched feature vectors is reproduced.

However, a probability that the boundary frame becomes an I frame (intrapicture) in the reproduction in units of a shot is only 1/N (where N is the number of frames contained in a group of pictures (GOP)), and thus the previous GOP should be first reproduced so as to reproduce a shot, resulting in requiring much time to reproduce the shot.

FIG. 2 illustrates a conventional reproduction method in units of a shot. Two consecutive shots are shown in FIG. 2. A shot A and a shot C include a plurality of frames, and a boundary is formed between the shot A and the shot C. A first frame 102 of the shot C becomes a boundary frame.

As shown in FIG. 2, the boundary between the shot A and the shot C exists in the GOP, and the boundary frame of the shot C is a B frame (bi-directionally predicted picture).

Because the boundary frame 102 of the shot C is the B frame, the I frame contained in the shot A should be first reproduced in the corresponding GOP so as to reproduce the shot C. That is, because the I frame contained in the previous shot should be referred to when the shot C is reproduced, a time in preparation to reproduce the shot C is required, and thus a start time to reproduce the shot C is delayed. Such problems occur even when the boundary frame is a predicted (P) frame.

Further, in the case of reproducing the key frame, a probability that the key frame becomes the I frame is only 1/N like in the boundary frame in the reproduction in units of shot, and thus, the beginning of the GOP should be reproduced, resulting in requiring much time to reproduce the key frame.

FIG. 3 illustrates a conventional method to reproduce a key frame. One shot A having a GOP structure is shown in FIG. 3, and a key frame 302 of the shot A is a B frame (a bi-directionally predicted picture).

Because the key frame 302 is the B frame, an I frame (intrapicture) contained in the corresponding GOP should be first reproduced so as to reproduce the key frame 302. That is, because the I frame contained in the corresponding GOP should be referred to when the key frame 302 of the shot A is reproduced, a time in preparation to reproduce the shot C is required, and thus, a start time to reproduce the key frame 302 is delayed. Such problems occur even when the key frame is a P frame (predicted picture).

### SUMMARY OF THE INVENTION

Various aspects and advantages of the invention will be set forth in part in the description that follows and, in part, will be obvious from the description, or may be learned by practice of the invention.

In accordance with an embodiment of the present invention, there is provided a method for encoding moving picture data suitable to navigate PVRs and content-based retrieval.

In accordance with an aspect of the present invention, there is provided an apparatus suitable of the method to encode moving picture data.

In accordance with an aspect of the present invention, there is provided a method to transcode moving picture data to navigate PVRs and content-based retrieval.

In accordance with an aspect of the present invention, there is provided an apparatus suitable of the method to transcode moving picture data.

In accordance with an aspect of the present invention, there is provided method to encode moving picture data in which the moving picture data having frames is segmented into a group of pictures (GOP) comprising an I frame (intrapicture), a B frame (bi-directionally predicted picture), and a P frame (predicted picture) and is encoded. The method includes segmenting inputted video data into the GOP and encoding the inputted video data, extracting a boundary between shots from the inputted video data, determining whether a frame to be encoded is a first frame (boundary frame) of a next shot, terminating the GOP in a frame (previous frame) before a key frame, and starting a new GOP from the boundary frame when the frame to be encoded is the boundary frame.

In accordance with an aspect of the present invention, there is provided method to encode moving picture data in which the moving picture data having a plurality of frames is segmented into a group of pictures (GOP) comprising an I frame (intrapicture), a B frame (bi-directionally predicted picture), and a P frame (predicted picture) and is encoded. The method includes segmenting the moving picture data into the GOP and encoding the moving picture data, extracting a key frame from the moving picture data, determining whether a frame to be encoded is the key frame, terminating the GOP in a frame (previous frame) before the key frame, and starting a new GOP from the key frame when the frame to be encoded is the key frame.

In accordance with an aspect of the present invention, there is provided an apparatus to encode moving picture data in which the moving picture data having frames is segmented into a group of pictures (GOP) comprising an I frame (intrapicture), a B frame (bi-directionally predicted picture), and a P frame (predicted picture) and is encoded. The apparatus includes a shot detector to detect a boundary between shots from the moving picture data and output a detection result indicative thereof, and an encoder to segment the moving picture data into the GOP, to encode the moving picture data, and to refer to the detection result to segment the GOP at the boundary between shots.

In accordance with an aspect of the present invention, there is provided a method to transcode a moving picture bit stream in units of a group of pictures (GOP) comprising an I frame (intrapicture), a B frame (bi-directionally predicted picture), and a P frame (predicted picture). The method includes decoding moving picture data from a bit stream, segmenting the moving picture data into the GOP and encoding the moving picture data, extracting a boundary between shots from the moving picture data, determining whether a frame to be encoded is a first frame (boundary frame) of a next shot, terminating GOP in a frame (previous frame) before a key frame, and starting a new GOP from the boundary frame when the frame to be encoded is the boundary frame.

In accordance with an aspect of the present invention, there is provided a method to transcode a moving picture bit stream in units of group of pictures (GOP) comprising an I frame (intrapicture), a B frame (bi-directionally predicted picture), and a P frame (predicted picture). The method includes decoding moving picture data from a bit stream, segmenting the moving picture data into the GOP, encoding the moving picture data, extracting a key frame from the moving picture data, determining whether a frame to be encoded is the key frame, terminating the GOP in a frame (previous frame) before the key frame, and starting a new GOP from the key frame when the frame to be encoded is the key frame.

In accordance with an aspect of the present invention, there is provided an apparatus to transcode a moving picture bit stream in units of a group of pictures (GOP) comprising an I frame (intrapicture), a B frame (bi-directionally predicted picture), and a P frame (predicted picture). The apparatus includes a decoder to decode moving picture data from a bit stream, a shot detector to detect a boundary between shots from the moving picture data and output a detection result indicative thereof, and an encoder to segment the moving picture data into the GOP, to encode the moving picture data, and to refer to the detection result to segment the GOP at the boundary between shots.

These together with other aspects and advantages which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

These and other aspects and advantages of the present invention will become more apparent by describing in detail preferred embodiments thereof with reference to the attached drawings in which:

FIG. 1 illustrates features of content-based retrieval;

FIG. 2 illustrates a conventional reproduction method in units of a shot;

FIG. 3 illustrates a conventional method to reproduce a key frame;

FIG. 4 illustrates a structure of a group of pictures (GOP);

FIG. 5 is a block diagram illustrating a structure of a conventional MPEG-2 encoder;

FIG. 6 is a block diagram illustrating a structure of a conventional transcoder;

FIG. 7 illustrates an example of a method to encode moving picture data according to an embodiment of the present invention;

FIG. 8 is a flow chart illustrating an example of a method to encode the moving picture data according to an embodiment of the present invention;

FIG. 9 illustrates another example of a method to encode the moving picture data according to an embodiment of the present invention;

FIG. 10 is a flow chart illustrating another example of a method to encode the moving picture according to an embodiment of the present invention;

FIG. 11 is a block diagram illustrating an example of an encoder according to an embodiment of the present invention;

FIG. 12 illustrates an example of a method to transcode the moving picture data according to an embodiment of the present invention;

FIG. 13 is a flow chart illustrating an example of a method to transcode the moving picture data according to an embodiment of the present invention;

FIG. 14 illustrates another example of a method to encode the moving picture data according to an embodiment of the present invention;

FIG. 15 is a flow chart illustrating another example of a method to transcode the moving picture data according to an embodiment of the present invention; and

FIG. 16 is a block diagram illustrating an example of a transcoder according to an embodiment of the present invention.

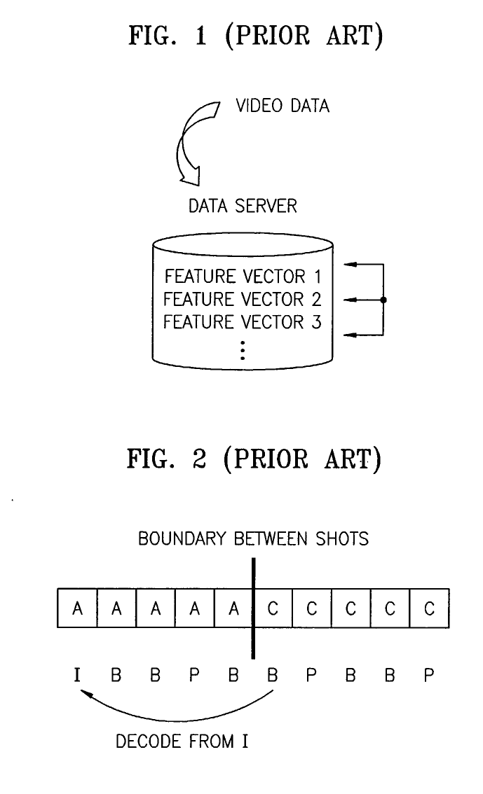

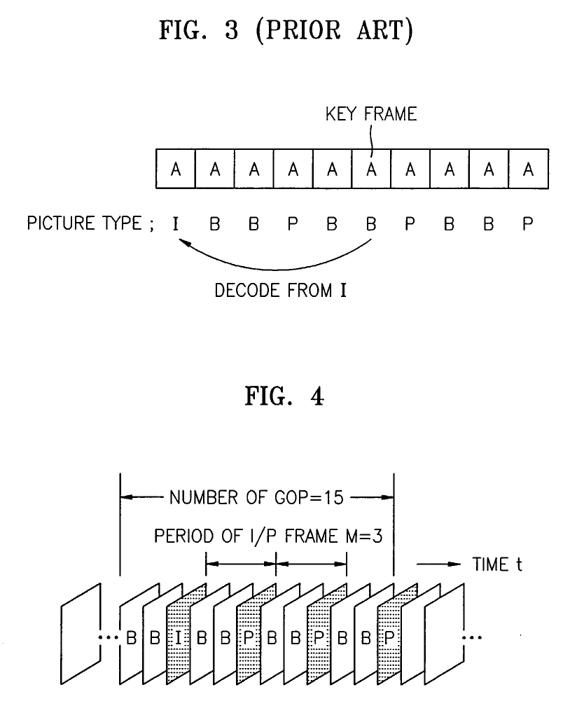

### DETAILED DESCRIPTION OF THE PREFERRED EMBODIMENTS

Hereinafter, embodiments of the present invention will be described in detail with reference to the attached drawings. The present invention may, however, be embodied in many different forms and should not be construed as being limited to the embodiments set forth herein; rather, these embodiments are provided so that the present disclosure will be thorough and complete, and will fully convey the concept of the invention to those skilled in the art.

It is well known that MPEG-2 video has a layered data structure, and a layer including a video sequence layer, a group of pictures (GOP) layer, a picture layer, a macroblock (MB) slice layer, an MB layer, and a block layer.

Here, the GOP represents a collection of consecutive pictures, and FIG. 4 illustrates the structure of the GOP.

Frames of the GOP include an I frame (intrapicture), a P frame (predicted picture), or a B frame (bi-directionally predicted picture).

All of the I frames are encoded in a same order as an original video. The P frame is encoded by interframe prediction in a forward direction, and the B frame is encoded by interframe bi-directional prediction (prediction in forward and reverse directions).

The GOP includes a variable M representing a period of the I/P frame and a variable of a number of frames in the GOP. As the variables M and N increase, a compression rate increases, but picture quality deteriorates.

Because the B frame is used in MPEG, an order of the frames in a bit stream may be different from the order of the frames decoded by a decoder. That is, the P frame to be outputted after the B frame is outputted is required when the B frame is restored, and thus, the P frame should be first restored. This causes a delay between the B frame and the P frame. An example thereof is as follows:

Frame order in a bit stream

Frame type B B I B B P B B P B B P

Frame No. 0 1 2 3 4 5 6 7 8 9 10 11

Decoding order

Frame type I B B P B B P B B P B B

Frame No. 2 0 1 5 3 4 8 6 7 11 9 10

In the above example, the I frame having a frame number 2 is first decoded, and the B frame having frame numbers 0 and 1 is decoded using information of the I frame. In order to decode the B frame having frame numbers 3 and 4, the I frame having the frame number 2 and the P frame having a frame number 5 are required; and thus, the P frame having the frame number 5 is decoded before the B frame having the frame numbers 3 and 4 is decoded. In this way, the frames from the I frame having the frame number 2 to the B frame having a frame number 10 are decoded.

When an uncompressed video is encoded, consecutive frames are segmented into the GOP, and are determined as one of type of picture such as the intrapicture (I), the bi-directionally predicted picture (B), and the predicted picture (P), by which each frame contained in the GOP is to be encoded, and are encoded according to the type of picture.

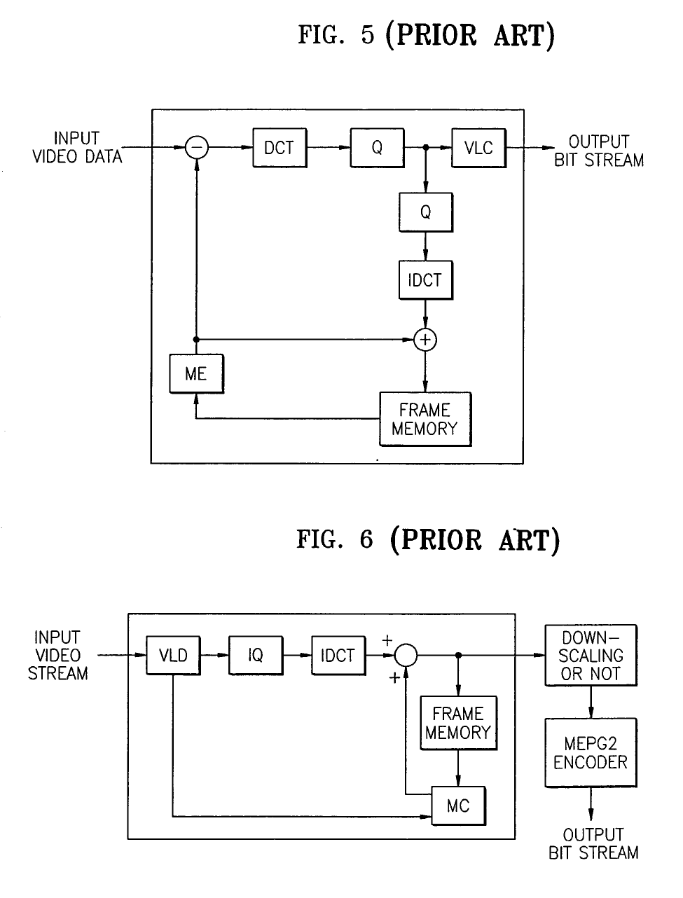

FIG. 5 is a block diagram illustrating a structure of a conventional MPEG-2 encoder. It is well known that the conventional MPEG-2 encoder includes a discrete cosine transform (DCT) converter to remove a spatial correlation, a movement estimator (ME) to remove a temporal correlation, a quantizer for a high efficiency lossy compression, an inverse quantizer and an inverse DCT converter to obtain a restored video, a frame memory in which the restored video is stored, and a variable length coder (VLC) for entropy encoding. The conventional MPEG-2 encoder shown in FIG. 5 inputs an uncompressed video and outputs an MPEG bit stream having a layered structure, in particular, an MPEG bit steam having the GOP structure. For this purpose, the conventional MPEG-2 encoder divides consecutive frames into the GOP and determines the consecutive frames as one of the type of pictures such as the intrapicture (I), the bi-directionally predicted picture (B), and the predicted picture (P) by which each frame contained in the GOP is to be encoded, and encodes the consecutive frames according to the type of picture.

The basic structure of the MPEG encoding is shown in FIG. 5, and other encoders based on the basic structure of the MPEG encoding having various shapes are presented in FIG. 5. For example, there are modified encoders to control a quantization rate according to a complexity of a video or to have a buffer memory to control a bit rate. However, these encoders output the bit stream having the GOP structure from uncompressed video data. Hereinafter, these encoders are referred to as the MPEG-2 encoders.

A scene is a unit to transmit video meaning. In general, the scene to make the meaning includes several shots. The scene deals with cases which occur in a same space and place.

On the other hand, a shot is the most basic video unit of all moving pictures. The shot means one scene taken without stoppage in one direction and is a scene taken until an end button operates after a recording button of a camera operates. Meanwhile, an already made shot of a movie or television means a piece of performance focused by the camera, that is, a scene during screen conversion.

In general, several scenes in a moving picture signal are connected to one another in an order of time, and a boundary between scenes is not considered when the moving picture signal is encoded. As a result, the GOP exists over the boundary between scenes. Accordingly, the boundary between scenes has no meaning in the conventional MPEG-2 encoder. That is, the conventional MPEG-2 encoder allocates a uniform GOP to an uncompressed video signal without discrimination of scenes and encodes the uncompressed video signal. Thus, the GOP exists over the boundary between scenes.

Accordingly, in an apparatus to reproduce the bit stream stored in a storage medium in which the moving picture signal is stored, in particular, in a personal video recorder (PVR) and a content-based retrieval system, a frame contained in the previous scene, as well as, frame information of a corresponding scene is referred to such that the retrieved scene is reproduced.

Accordingly, transcoding such as a resolution conversion, scan format, interlace/non-interlace conversion, and conversion of a screen size needs to be performed in the bit stream. The most basic transcoding method is to encode the bit stream to obtain the uncompressed video data (even though some losses occur due to compression encoding previously performed), and if necessary, to down-sample the uncompressed video data and encode a down-sampled uncompressed video data at a required resolution.

An apparatus to transcode is a conventional trancoder shown in FIG. 6.

FIG. 6 is a block diagram illustrating a structure of the conventional transcoder. The transcoder shown in FIG. 6 includes an MPEG decoder to restore an uncompressed video data from a bit stream (even though some losses occur due to compression encoding previously performed), a down-sampler to down-sample the uncompressed video data, a converter to convert a scan format, and the MPEG-2 encoder to encode the down-sampled uncompressed video data.

Modified transcoders having various shapes are presented based on the transcoder shown in FIG. 5. Transcoders having the decoder to decode all or part of the bit stream are presented. However, all these transcoders have the MPEG-2 encoder and output a bit stream having a uniform GOP structure without discriminating the scenes. Accordingly, the bit stream outputted by the conventional MPEG-2 encoder or the transcoder is inappropriate to navigate for the PVR and the content-based retrieval and storage.

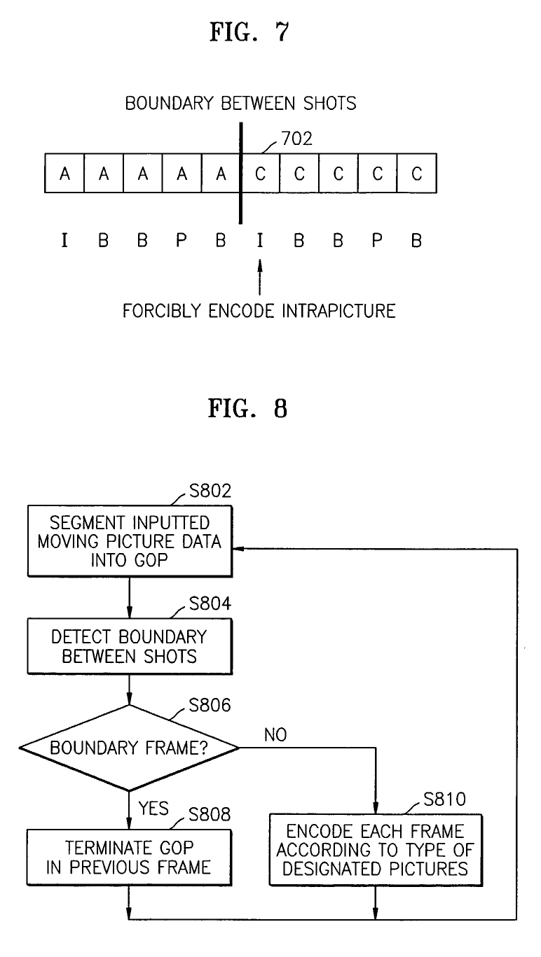

FIG. 7 illustrates an example of a method to encode the moving picture data according to an embodiment of the present invention. A video data having two consecutive shots is shown in FIG. 7. A shot A and a shot C include a plurality of frames, and a boundary exists between the shot A and the shot C. A first frame 702 of the shot C becomes a boundary frame.

According to an embodiment of the present invention, a bit stream has the GOP structure at a boundary between shots. That is, the GOP is terminated in a previous frame and a new GOP starts from the boundary frame 702 such that the boundary frame 702 of the shot C always becomes an I frame (intrapicture).

A number of frames contained in the GOP is usually between 12 and 15, but there is no special limitation in the number of frames. However, a first frame of the GOP becomes the I frame, and thus if the GOP is terminated at the boundary between shots, a next frame, i.e., the boundary frame 702 becomes the I frame. Thus, in the case of reproduction in units of a shot, the beginning of the GOP, i.e., from the I frame can be reproduced. Unlike in the prior art, the frames contained in another shot need not be reproduced.

Here, the GOP is terminated at the boundary between shots, and thus the last frame of the shot should be the P frame (predicted picture) or the B frame (bi-directionally predicted picture) in a reverse predicted mode.

FIG. 8 is a flow chart illustrating an example of a method to encode the moving picture data according to an embodiment of the present invention. At operation S802, an inputted moving picture data is segmented into the GOP. The inputted moving picture data is grouped by a number (N) of frames according to given variables N/M, and the type of pictures such as the intrapicture (I), the bi-directionally predicted picture (B), and the predicted picture (P)) of frames are determined. Each frame in the segmented GOP is designated as one among the type of pictures I, B, and P.

At operation S804, the inputted moving video data is analyzed, and then the boundary between shots is detected.

Until now, it is known that the most satisfactory result can be obtained when the boundary between shots is detected, that is, a color histogram is used for shot segmentation. However, in the shot segmentation method using global color distribution based on the color histogram, a picture level should be decoded such that color information of the video frame is obtained, and thus a speed of the shot segmentation is very slow.

In order to supplement slow speed of the shot segmentation using the global color distribution, the shot segmentation using features in a compressed region of an MPEG bit stream and characteristics of type of pictures such as the intrapicture (I), the bi-directionally predicted picture (B), and the predicted picture (P), and a screen change detection algorithm using the type of information in a macroblock at the same position as those of adjacent B frames and a table in which the adjacent B frames are compared with the macroblock, have been suggested.

Korean Patent Publication No. 1999-42518 (filed on Oct. 2, 1999, applicant: Electronics Telecommunications Research Institute, and published on May 7, 2001) discloses a shot segmentation method using joint point-based operation information. In addition, Korean Patent Publication No. 2000-80966 (filed on Dec. 12, 2000, applicant: Virtualmedia, and published on May 7, 2001) discloses an apparatus in which a predetermined object is tracked in a unit of a shot after a scene conversion detection process and anchor information is inserted in a region of the tracked object to manufacture a stream hyper video, such that a digital video data is effectively managed and edited in units of the shot.

At operation S806, by referring to a result of the shot boundary detection (SBD) at operation S804, the method determines whether the frame to be presently encoded is a boundary frame.

At operation S808, if the frame to be presently encoded is the boundary frame, the GOP is terminated in the previous frame and the method goes back to operation S802. For example, if a sixth frame having a frame number 15 is the boundary frame, the GOP is terminated in a fifth frame, and a new GOP starts from the sixth frame.

The GOP at the boundary between shots can be encoded by two methods. One method is to start the new GOP from the boundary between shots, and the other method is to segment the GOP at the boundary between shots into two GOPs.

Assuming that a number of an initially segmented GOP is 15, the GOP contained in the previous shot at the boundary between shots is GOP#1, the GOP contained in a next shot is GOP#2, and there is a boundary between the fifth frame and the sixth frame, according to the result of the method to encode the moving picture data according to an embodiment of the present invention. In the former case, a number of the GOP#1 is 5, and a number of the GOP#2 is less than 15, and in the latter case, the number of the GOP#1 is 5, and the number of the GOP#2 is less than 10. The number of the GOP#2 being less than 15 or 10 is a reason the GOP#2 can have a separate shot of less than 15 or 10 (even though a shot of less than 10 frames, that is, less than ⅓ second, does not exist).

In this case, if the last frame of the previous shot at the boundary between shots is the B frame, the B frame is encoded in a backward predicted mode. At operation S810, if the frame to be presently encoded is not the boundary frame, each frame is encoded according to the type of the designated pictures, and if the last frame of a corresponding GOP is encoded, the method goes back to operation S802.

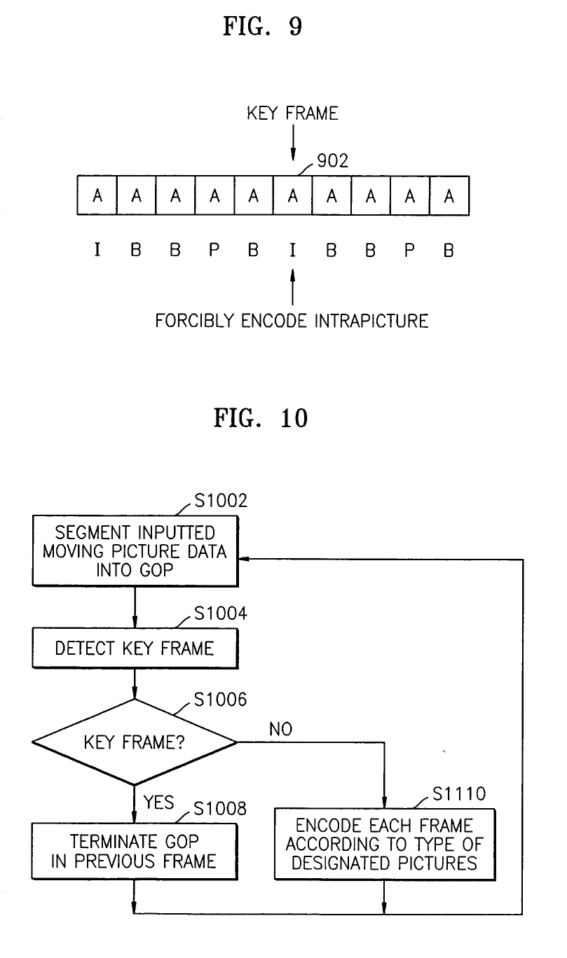

FIG. 9 illustrates another example of a method to encode the moving picture data according to an embodiment of the present invention. A shot A and a key frame 902 of the shot A are shown in FIG. 9.

According to another embodiment of the present invention, a bit stream has a GOP structure at a boundary between shots. That is, the GOP is terminated in the previous frame and the new GOP starts from the key frame 902 such that the key frame 902 of the shot A becomes an I frame (intrapicture).

The first frame of the GOP becomes the I frame, and thus if the GOP is terminated in a frame right before or immediately before the key frame 902, a next frame, i.e., the key frame 902 becomes the I frame. Thus, the key frame which is the I frame, can be reproduced. Unlike in the prior art, other frames of the GOP in which the key frame is contained, need not be reproduced.

Here, the GOP is terminated in the frame right before or immediately before the key frame, and thus the frame right before the key frame is the I frame, the P frame, or the B frame (bi-directionally predicted picture) in a backward predicted mode.

FIG. 10 is a flow chart illustrating another example of a method to encode the moving picture data according to an embodiment of the present invention.

At operation 1002, an inputted moving picture data is segmented into the GOP. The inputted moving picture data is grouped by a number (N) of frames according to given variables N/M, and the type of pictures such as the intrapicture (I), the bi-directionally predicted picture (B), and the predicted picture (P)) of frames are determined. Each frame in the segmented GOP is designated as one among the type of pictures I, B, and P. At operation S1004, the inputted moving video data is analyzed, and then the key frame of the shot is detected.

Korean Patent Publication No. 2001-708537 (filed on Jul. 4, 2001, applicant: Coninklike Philips Electronics N.V., and published on Oct. 8, 2001) discloses a method to detect a key frame based on a video cut between shots, a DCT coefficient and a macroblock.

In the above method, DC values of luminance and color difference blocks of a current macroblock from a current video frame, respectively, are subtracted from the DC values, which correspond to a block corresponding to the previous video frame. An individual sum SUM of differences is maintained in each of the luminance and color difference blocks of the macroblock.

If the SUM is less than a critical value, a static scene counter SScrt increases to indicate an available static scene (key frame). When the SScrt reaches a predetermined value, the foremost vide frame stored in temporary memory is selected as the key frame.

At operation S1006, by referring to the detection result at operation S1004, the method determines whether the frame to be presently encoded is the key frame.

At operation S1008, if the frame to be presently encoded is the key frame, the GOP is terminated in the previous frame and goes back to operation S1002. For example, if the sixth frame having a frame number 15 is the key frame, the GOP is terminated in the fifth frame, and the new GOP starts from the sixth frame.

The GOP near the key frame can be encoded by one of two methods. One method is to start a new GOP from the key frame, and the other method is to segment the GOP near the key frame into two GOPs.

Assuming that the number of the GOP segmented in operation 1002 is 15, the GOP before the key frame is GOP#1, the GOP after the key frame is GOP#2, and the sixth frame is the key frame, according to the result of the method to encode the moving picture data according to an aspect of the present invention, in the former case, the number of the GOP#1 is 5, and the number of the GOP#2 is 15, and in the latter case, the number of the GOP#1 is 5, and the number of the GOP#2 is 10.

In this case, if the frame right before the key frame is the B frame, the B frame is encoded in a backward predicted mode.

At operation S1010, if the frame to be presently encoded is not the key frame, each frame is encoded according to the type of the designated pictures, and if the last frame of the corresponding GOP is encoded, the method goes back to operation S1002.

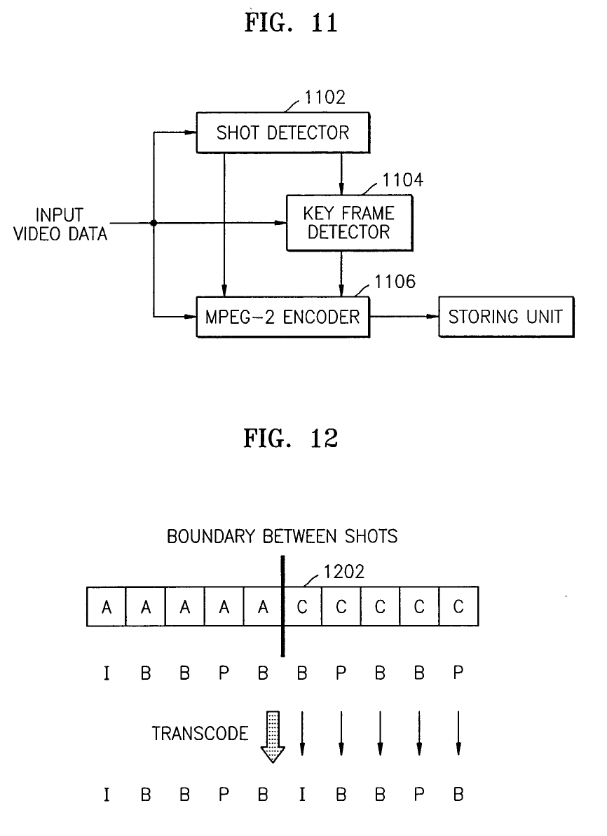

FIG. 11 is a block diagram illustrating an example of an encoder according to an embodiment of the present invention. An apparatus shown in FIG. 11 includes a shot detector 1102, a key frame detector 1104, and MPEG-2 encoder 1106. Here, the MPEG-2 encoder 1106 is a modification of the apparatus shown in FIG. 5 and performs encoding in a unit s of the GOP.

The shot detector 1102 detects the boundary between shots from inputted video data. Meanwhile, the MPEG-2 encoder 1106 refers to the detection results of the shot detector 1102 and the key frame detector 1104. The MPEG-2 encoder 1106 determines the GOP by referring to the detection results of the shot detector 1102 and the key frame detector 1104.

The MPEG-2 encoder 1106 segments the inputted video data into a given GOP structure, encodes the inputted video data, and terminates the previous GOP in the boundary frame or the key frame and starts a new GOP. The shot detector 1102 detects the boundary frame, and the key frame detector 1104 detects the key frame.

FIG. 12 illustrates an example of a method to transcode the moving picture data according to an embodiment of the present invention. A bit stream having a video data including two consecutive shots A and C is shown in FIG. 12.

The shots A and C include a plurality of frames, and a boundary exists between the shot A and the shot C. A first frame 1202 of the shot C becomes a boundary frame.

According to an example of the present invention, the bit stream has the GOP structure at the boundary between the shots. That is, the GOP is terminated in the previous frame and the new GOP starts from the boundary frame 1202 such that the boundary frame 1202 of the shot C becomes the I frame (intrapicture).

Here, the GOP is terminated at the boundary between shots, and thus the last frame of the shot is the P frame (predicted picture) or the B frame (bi-directionally predicted picture) in a backward predicted mode.

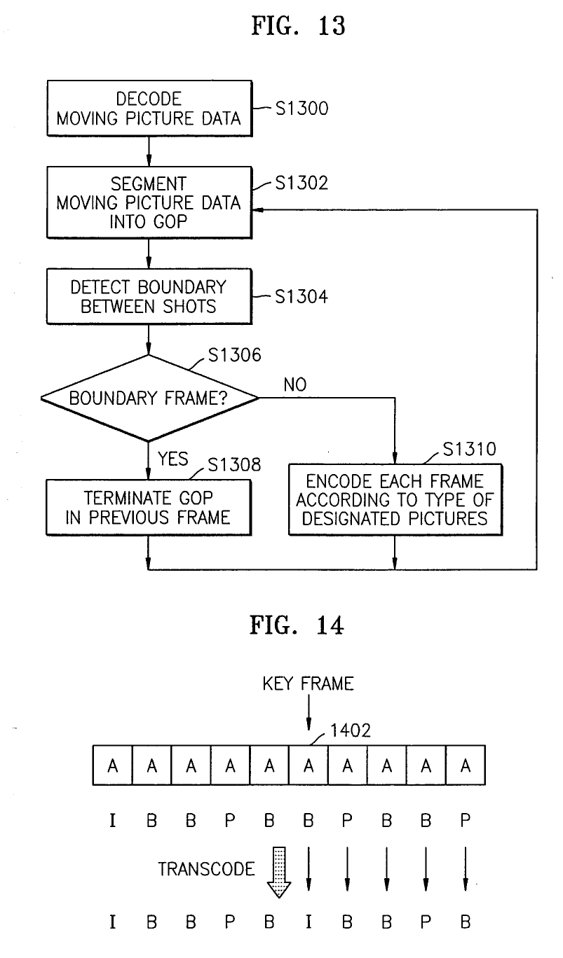

FIG. 13 is a flow chart illustrating an example of a method to transcode the moving picture data according to an embodiment of the present invention.

At operation S1300, the moving picture data is decoded from the inputted bit stream.

At operation S1302, the encoded moving picture data is segmented into the GOP. The decoded moving picture data is grouped by a number (N) of frames according to given variables N/M, and the type of pictures such as the intrapicture (I), the bi-directionally predicted picture (B), and the predicted picture (P)) of frames are determined.

Each frame in the segmented GOP is designated as one among the type of pictures I, B, and P.

At operation S1304, the inputted moving video data is analyzed, and then the boundary between shots is detected.

At operation S1306, by referring to a result of the detection at operation S1304, the method determines whether the frame to be presently encoded is the boundary frame.

At operation S1308, if the frame to be presently encoded is the boundary frame, the GOP is terminated in the previous frame and the method goes back to operation S1302. For example, if the boundary exists between the fifth frame and the sixth frame of the GOP having the frame number 15, the GOP is terminated in the fifth frame, and the new GOP starts from the sixth frame.

In this case, if the last frame of the previous shot at the boundary between shots is the B frame, the B frame is encoded in the backward predicted mode.

At operation S1310, if the frame to be presently encoded is not the boundary frame, each frame is encoded according to the type of the designated pictures, and if the last frame of the corresponding GOP is encoded, the method goes back to operation S1302.

FIG. 14 illustrates another example of a method to encode the moving picture data according to the present invention. The bit stream A having one shot A and the key frame 1402 of the shot A are shown in FIG. 14.

According to another example of the present invention, the bit stream has the GOP structure in the key frame of the shot. That is, the GOP is terminated in the previous frame and the new GOP starts from the key frame 1402 such that the key frame 1402 of the shot A becomes the I frame (intrapicture).

The first frame of the GOP becomes the I frame, and thus if the GOP is terminated in a frame right before the key frame 1402, a next frame, i.e., the key frame 1402 becomes the I frame. Thus, the key frame which is the I frame, can be reproduced. Unlike in the prior art, other frames of the GOP in which the key frame is contained, need not be reproduced.

Here, the GOP is terminated at the boundary between shots, and thus the last frame of the shot is the P frame (predicted picture) or the B frame (bi-directionally predicted picture) in the backward predicted mode.

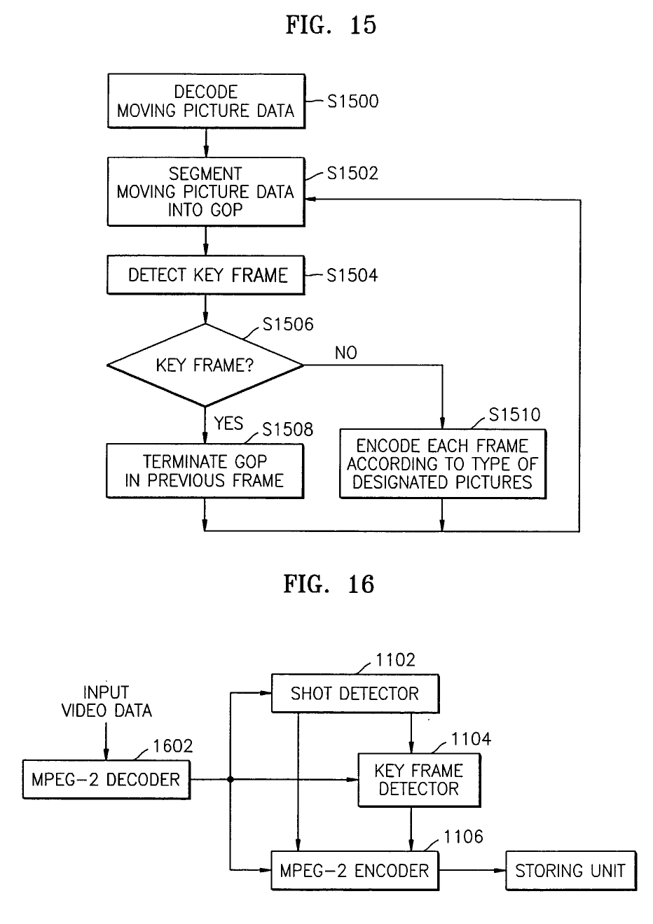

FIG. 15 is a flow chart illustrating another example of a method to transcode the moving picture data according to an embodiment of the present invention.

At operation S1500, the moving picture data is decoded from the inputted bit stream.

At operation S1502, the encoded moving picture data is segmented into the GOP. The decoded moving picture data is grouped by the number (N) of frames according to given variables N/M, and the type of pictures are determined such as the intrapicture (I), the bi-directionally predicted picture (B), and the predicted picture (P)) of frames.

Each frame in the segmented GOP is designated as one among the type of pictures I, B, and P.

At operation S1504, the inputted moving video data is analyzed, and then the key frame of the shot is detected.

At operation S1506, by referring to a result of the detection in operation S1504, it is determined whether the frame to be presently encoded is the key frame.

At operation S1508, if the frame to be presently encoded is the key frame, the GOP is terminated in the previous frame and the method goes back to operation S1502. For example, if the sixth frame of the GOP having the frame number 15 is the key frame, the GOP is terminated in the fifth frame, and a new GOP starts from the sixth frame.

The GOP near the key frame can be encoded by two methods. One method is to start the new GOP from the key frame, and the other method is to segment the GOP near the key frame into two GOPs.

In this case, if the frame right before the key frame is the B frame, the B frame is encoded in the backward predicted mode.

At operation S1510, if the frame to be presently encoded is not the key frame, each frame is encoded according to the type of designated pictures, and if the last frame of the corresponding GOP is encoded, the method goes back to operation S1502.

FIG. 16 is a block diagram illustrating an example of a transcoder according to an embodiment of the present invention. In an apparatus shown in FIG. 16, like reference numerals refer to like elements to perform the same operations as those of the apparatus shown in FIG. 11, and detailed descriptions will be omitted.

The apparatus shown in FIG. 16 further includes an MPEG-2 decoder 1602. Here, the MPEG-2 encoder 1106 corresponds to a modification of the apparatus shown in FIG. 5 and performs encoding in the unit s of the GOP. The MPEG-2 decoder 1602 corresponds to the apparatus shown in FIG. 6 and modification of the apparatus shown in FIG. 6 and encodes an uncompressed video data from a bit stream (even though some losses occur due to the compression encoding previously performed).

The shot detector 1102 detects the boundary between the shots from,the inputted video data. Furthermore, the key frame detector 1104 detects the key frame of the shot.

The detection results of the shot detector 1102 and the key frame detector 1104 are referred to by the MPEG-2 encoder 1106. The MPEG-2 encoder 1106 determines the GOP by referring to the detection results of the shot detector 1102 and the key frame detector 1104.

The MPEG-2 encoder 1106 segments the inputted video data into a given GOP structure, encodes the inputted video data and terminates the previous GOP in the boundary frame or key frame and starts the new GOP. The boundary frame is detected by the shot detector 1102, and the key framed is detected by the key frame detector 1104.

Even though the MPEG encoding method is disclosed in embodiments of the present invention, it is well known by a person skilled in the art that the method to encode the moving picture data according to embodiments of the present invention can be adopted in applications such as H.261 and HPEG having a GOP structure, as well as an MPEG structure.

As described above, in a method to encode moving picture data according to an embodiment of the present invention, a group of pictures (GOP) is segmented in a first frame (boundary frame) and a key frame of a shot such that other shots and frames need not be referred to in personal vide recorders (PVRs), content-based retrieval and reproduction of the shot and the key frame, and then a time to reproduce is reduced. Accordingly, in the method to encode the moving picture data according to embodiments of the present invention, navigation of PVRs can be smoothly performed, and multimedia information can be effectively managed.

The various features and advantages of the invention are apparent from the detailed specification and, thus, it is intended by the appended claims to cover such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to encode moving picture data in which the moving picture data having frames is segmented into a group of pictures (GOP) comprising an I frame (intrapicture), a B frame (bi-directionally predicted picture), and a P frame (predicted picture) and is encoded, the method comprising:
segmenting inputted video data into the GOP and encoding the inputted video data;
extracting a boundary between shots from the inputted video data;
determining whether a frame to be encoded is a first frame (boundary frame) of a next shot;
terminating the GOP in a frame (previous frame) before a key frame; and
starting a new GOP from the boundary frame when the frame to be encoded is the boundary frame.

2. The method of claim 1, wherein the GOP is terminated in the previous frame immediately before the key frame.

3. The method of claim 1, wherein when the previous frame is the B frame, the previous frame is encoded in a backward predicted mode.

4. The method of claim 1, wherein the boundary frame of the GOP is the I frame when the GOP is terminated at the boundary between the shots.

5. The method of claim 1, wherein a color histogram is used for shot segmentation.

6. The method of claim 5, further comprising:
decoding a picture level to obtain color information.

7. The method of claim 1, further comprising:
encoding each frame according to a type of designated pictures I, B, or P when the frame to be encoded is not the boundary frame.

8. The method of claim 1, further comprising:
segmenting the new GOP at the boundary between shots when the frame to be encoded is the boundary frame.

9. A method to encode moving picture data in which the moving picture data having a plurality of frames is segmented into a group of pictures (GOP) comprising an I frame (intrapicture), a B frame (bi-directionally predicted picture), and a P frame (predicted picture) and is encoded, the method comprising:
segmenting the moving picture data into the GOP and encoding the moving picture data;
extracting a key frame from the moving picture data;
determining whether a frame to be encoded is the key frame;
terminating the GOP in a frame (previous frame) before the key frame; and
starting a new GOP from the key frame when the frame to be encoded is the key frame.

10. The method of claim 9, wherein the GOP is terminated in the previous frame immediately before the key frame.

11. The method of claim 9, wherein when the previous frame is the B frame, the previous frame is encoded in a backward predicted mode.

12. The method of claim 9, further comprising:
encoding each frame according to a type of designated pictures I, B, or P when the frame to be encoded is not the key frame.

13. An apparatus to encode moving picture data in which the moving picture data having frames is segmented into a group of pictures (GOP) comprising an I frame (intrapicture), a B frame (bi-directionally predicted picture), and a P frame (predicted picture) and is encoded, the apparatus comprising:
a shot detector to detect a boundary between shots from the moving picture data and output a detection result indicative thereof; and
an encoder to segment the moving picture data into the GOP, to encode the moving picture data, and to refer to the detection result to segment the GOP at the boundary between shots.

14. The apparatus of claim 13, wherein when a frame (previous frame) before a key frame is the B frame, the encoder encodes the previous frame in a backward predicted mode.

15. The apparatus of claim 13, further comprising:
a key frame detector to detect a key frame of a shot from the moving picture data, wherein the encoder segments the GOP at the boundary between the shots and in the key frame by referring to the detection result of the shot detector and the key frame detector.

16. The apparatus of claim 13, wherein the apparatus comprises one of an H.261, HPEG, and MPEG.

17. A method to transcode a moving picture bit stream in units of a group of pictures (GOP) comprising an I frame (intrapicture), a B frame (bi-directionally predicted picture), and a P frame (predicted picture), the method comprising:
decoding moving picture data from a bit stream;
segmenting the moving picture data into the GOP and encoding the moving picture data;
extracting a boundary between shots from the moving picture data;
determining whether a frame to be encoded is a first frame (boundary frame) of a next shot;
terminating GOP in a frame (previous frame) before a key frame; and
starting a new GOP from the boundary frame when the frame to be encoded is the boundary frame.

18. The method of claim 17, wherein the GOP is terminated in the previous frame immediately before the key frame.

19. The method of claim 17, wherein when the previous frame is the B frame or the P frame, the previous frame is encoded in a backward predicted mode.

20. The method of claim 17, further comprising:
encoding each frame according to a type of designated pictures I, B, or P when the frame to be encoded is not the boundary frame.

21. A method to transcode a moving picture bit stream in units of group of pictures (GOP) comprising an I frame (intrapicture), a B frame (bi-directionally predicted picture), and a P frame (predicted picture), the method comprising:
decoding moving picture data from a bit stream;
segmenting the moving picture data into the GOP;
encoding the moving picture data;
extracting a key frame from the moving picture data;
determining whether a frame to be encoded is the key frame;
terminating the GOP in a frame (previous frame) before the key frame; and
starting a new GOP from the key frame when the frame to be encoded is the key frame.

22. The method of claim 20, wherein the GOP is terminated in the previous frame immediately before the key frame.

23. The method of claim 20, further comprising:
encoding each frame according to a type of designated pictures I, B, or P when the frame to be encoded is not the key frame.

24. The method of claim 20, wherein when the previous frame is the B frame, the previous frame is encoded in a backward predicted mode.

25. An apparatus to transcode a moving picture bit stream in units of a group of pictures (GOP) comprising an I frame (intrapicture), a B frame (bi-directionally predicted picture), and a P frame (predicted picture), the apparatus comprising:
a decoder to decode moving picture data from a bit stream;
a shot detector to detect a boundary between shots from the moving picture data and output a detection result indicative thereof; and
an encoder to segment the moving picture data into the GOP, to encode the moving picture data, and to refer to the detection result to segment the GOP at the boundary between shots.

26. The apparatus of claim 25, wherein when a frame (previous frame) right before a key frame is the B frame, the encoder encodes the previous frame in a backward predicted mode.

27. The apparatus of claim 25, further comprising:
a key frame detector to detect a key frame of a shot from the moving picture data, wherein the encoder segments the GOP at the boundary between the shots and in the key frame by referring to the detection result of the shot detector and the key frame detector.

28. The apparatus of claim 25, wherein the apparatus comprises one of an H.261, HPEG, and MPEG.
